(19) United States
(12) Patent Application Publication
(10) Pub. No.: US 2007/0239523 A1
(43) Pub. Date: Oct. 11, 2007

(54) Method and System for Advanced Reward Program

(76) Inventor: Jun Yi, San Jose, CA (US)

Correspondence Address: JUN YI, 221 BIRCH RIDGE CIRCLE, SAN JOSE, CA, 95123, US

(21) Appl. No.: 11/278,433

(22) Filed: Apr. 3, 2006

(51) Int. Cl. G06Q 30/00

(52) U.S. Cl. 705/14

(57) ABSTRACT

The present invention provides business process, method and computer based techniques for reward program operators to offer reward point advance to their members. Both multi-partner and proprietary reward applications can utilize the present invention to attract new customers, retain existing customers and increase sales volume. A preferred embodiment of the present invention involves a credit account established by a financial institution, especially a credit card issuer. A coalition reward program can take full advantage of the present invention by leveraging value propositions of financial institutions, retailers, merchants, service providers, manufacturers, etc. A credit card issuer owning a reward platform can be at the best position to implement the present invention with minimal incremental investments.

### REFERENCE TO RELATED APPLICATIONS

This application claims the benefit of PPA APPL No. 60/763,658, filed 2006 January 31st by the present inventor.

### FIELD OF THE INVENTION

The present invention relates to a few areas. First, the present invention creates a business method to issue a credit or loan which is paid back with reward earned in the future. Second, the present invention develops a business method for merchants, service providers, manufacturers and financial institutions to conduct loyalty marketing or promotional marketing. Finally, the present invention develops a set of computer based systems and financial transaction methods for a coalition reward program operator to manage a reward program network involving multiple partners.

### BACKGROUND OF THE INVENTION

Reward or rebate program is one of the most popular marketing tools for sponsor companies to build customer loyalty. Towergroup, a consulting firm focusing on financial services industry, defines Reward Program as: “A focused and positive way to tell customers that company appreciates their patronage and loyalty, by giving value back. It creates a compelling reason for customers to keep coming back.” There are different terms used to represent the similar meaning of reward, such as award, rebate, coupon, incentive, and etc. In the documents related with the application for the present invention, those terms are interchangeable although reward is used most frequently. Reward point is used in this application as the unit of reward currency to measure the value of reward.

Reward program is used by various industries. For instance, some airlines offer customers “free” mileage based on respective total mileage amounts that customers have accrued over a span of time (thus providing a type of “frequency-based” reward program). Some stores (such as supermarkets) monitor the purchases of customers and then provide various reward to the customers based on the volume and/or composition of the customers' purchases. Store-based reward programs typically identify the customers at the checkout stand and then post the customers' purchases to respective customer accounts.

Financial card systems may also offer reward. The known DISCOVER® card provides a relatively small annual cash rebate to cardholders based on the aggregate value of the cardholders' purchases in the course of the year. The card provider distributes the rebate via a check or like means of payment (such as discount coupons). Upon receipt, the cardholders are free to spend the rebates in any manner that they deem appropriate.

A coalition reward program is anther natural result of the development of loyalty marketing, especially with the help of information technology and internet. Www.mypoints.com and www.goldpoints.com are two typical examples of internet based coalition reward programs. They build partnership with reward sponsors in different industries, including financial services, retailers, travel and entertainment, and etc. Members of those two coalition reward programs can earn reward points by purchasing merchandise or services from reward sponsors through the direction of reward websites.

By year-end 2000, Colloquy, a magazine serving the loyalty marketing industry, estimated that total U.S. consumer reward membership at 973 million-an average of more than four programs per adult-yielding a market size of US $1.8 billion exclusive of reward costs. Credit card issuers and airlines are two industries that use the reward programs extensively. According to Web Flyer, there are 89 million members of airline frequent-flyer programs in the world, 74 million of them in the U.S. alone. According to Cardweb.com, more than 40 percent of all Visa and MasterCard issuers now operate a reward program tied to their credit card offering. Colloquy estimates that loyalty program penetration among U.S. debit card issuers is already at 20 percent and rising rapidly.

And two recently announced reward marketing initiatives demonstrate the popularity of reward marketing again. New York Times rolled out a point reward program on Jan. 19, 2006 and Yahoo is sending out survey to 5% of its members to ask for the feedback of setting up a reward program for users to use Yahoo's search engine.

However, current reward model faces problems of stunning sameness in offerings and lacking capabilities to lock up members. Across industries, consumer fatigue and boredom appear to be directly tied to the unimaginative redemption choices. Research conducted by Quadstone in late 2001, for example, revealed that the trend of consumer boredom with loyalty was well underway.

Among the sample of 1,000 consumers surveyed, 19 percent claimed that they “usually forget” about the reward program points they have earned and that the points “expire before I use them”.

Focus groups conducted by Colloquy in the hotel frequent guest category revealed that once the branding and logos were removed from the reward catalogs, members could not tell the difference between programs.

Among those consumers who did not own a loyalty card, nearly half (47%) said that they had no interest in them, with 19 percent of consumers saying that they “do not see the benefit”.

To resolve above issues, reward program sponsors are aggressively creating new reward practices. One method is to offer big ticket up-front incentive. Such a practice services three purposes: to create a “Wow Factor” to attract customers, to differentiate the reward program from the competitor's and to supply customers an immediate satisfaction. However, many customers take advantage of this practice at the expense of reward program operators. Customers enroll, cash the bonus then forget the program. With the cost of getting a new member becoming higher and higher, growing rate of inactive members is one of the biggest headaches of reward program operators.

Some reward program sponsors tried to require customers to perform pre-determined activities to qualify for the big ticket upfront incentives. First Merchant Bank issued a credit card which offered a free laptop in exchange for cardholder's making a certain amount of balance transfer and keeping such an interest generating balance for at least 18 months. Citibank recently issued a card which offers customers a free iPod if cardholder spends $500 minimum for consecutive three months. Those offers are trying to tie an upfront incentive with pre-determined activities thus develop customers' loyalty towards the product during this period of time.

However, above solutions lack a sophisticated pricing and management method. The responses from market were not very positive. First Merchant Bank's product does not give customers a true reward which should be based on the concept of “free”. It requires customers to conduct interest carrying balance transfers and keep those balances for 18 months. With lot of 0% balance transfer offers in the market, First Merchant Bank's offer sounds more like getting a discount from already overpriced product rather than being awarded for prices customers have to pay regardless. Citibank's offer provides true reward. However, such a one time bonus that only can tie customers for three months hardly protects card issuer's benefits. And for a generic product in cut-throat competition market, it is hard to assume customer's loyalty can be built in a three month period.

The most critical weakness of above offers is that they can not differentiate customers by the usage. Due to the rigid incentive plan, both of above offers are doing the adverse selection. Because customers get the same bonus, the more activities they perform, the less the return. If the value of the incentive is set at a relatively low level, product offers are not attractive. If the value of the incentive is set at a relatively high level, customers can play around the rule to take advantage of it but not necessary create value for the card issuer. For example, customers can take Citibank's offer, spend just $500 per month and pay down the balance. They walk away with a free iPod while Citibank earns nearly nothing. Another method is to provide an attractive enough incentive and at the mean time to increase the price of the product to compensate the extra cost, as what the First Merchant Bank did. However, in most cases customers are smart and know clearly what kind of competing offer they can get from the market.

So, for a successful upfront incentive reward program, at least four issues have to be addressed. First, to develop a business method that provides customers an attractive value. Second, to develop a business method that differentiates the customers by future usage. Third, to develop a business method that locks up customers long enough to build a true loyalty. Finally, to develop a business method that has positive motivation relationship to the customers, which means the more customers spend the more benefits they can get.

### SUMMARY OF THE NEW METHOD

The present invention will resolve problems mentioned above. Advanced Reward Program (referred to as ARP hereinafter) is the new business process and related computer based techniques for reward program operators to offer members a privilege to advance reward points before those rewards are earned. Although the upfront incentive mentioned in the present invention is mainly based on reward point advance, it is not exclusive of traditional up-front incentives that do not rely on the future reward. In fact, the combination of those two types of incentives can only enhance the effect of the present invention.

Following example is a typical ARP offer: if a customer expects that he or she can earn 50,000 reward points (at the equivalent US dollar value of $500, hereinafter 1 reward point always has the equivalent US dollar value of 1 cent) each year in a reward program, the customer can advance a $1,000 value up-front incentive by enrolling in a two year ARP. After the enrollment, each month the customer has to amortize at least 2% of the beginning reward advance balance with reward points accumulated. Per year, the customer has to amortize at least 50% of the total rewards advance. (It is simpler to set annual amortization rate equals the total of monthly rates. The method in the sample is trying to give customer more flexibility to deal with the fluctuation of daily spending)

If in any period, the customer does not have enough reward points to amortize the minimum amount required, he or she has to pay cash for the gap. For cash amortization part, an interest could be added according to pre-determined terms. In the following paragraphs, more detailed mechanisms of ARP offer are demonstrated from different aspects.

ARP creates new utilities and enforces the utility of current reward scheme in following areas: a new type of credit for customers to meet their financial needs; more value delivered to customers at the same reward rate; a powerful ‘wow factor’ for loyalty markers to attract customers; a tool for reward program sponsors to lock up customers' spending; a leverage to align the value propositions of different reward program sponsors and a foundation for further innovations in the reward marketing area.

ARP provides another source of borrowing for customers. According to the section of Background of the Invention, awarding customers' daily spending is ubiquitous business practice now. It is very reasonable to assume that customers will continue to get reward on daily spending in the foreseeable future. With appropriate risk management techniques and payment arrangement, it makes great business sense to allow customers to advance those future rewards. For some group of customers, such as students, small business owners, etc. such a new source of borrowing can be important for their occasional financial needs.

All others equal, ARP delivers more value to members comparing with the current practice. In current reward programs, customers can not redeem all the points they earned. There is always part of reward points staying on reward program operators' book forever because either points expire or amount of points can not reach the redemption hurdle. Time value of the money also counts. The money redeemed one year later has less economic value compared with the same amount of money taken upfront. From reward program operators' perspective, although those two factors save them some expenses, the factors also lower the interest of reward program members thus reduce the revenue.

The ARP increases the marketing power of the reward program significantly thus will become a great “wow factor’ for loyalty marketers. ARP provides immediate satisfaction to customers. In the current reward program, customers have to wait for an uncertain period of time to accrual enough points to redeem an item with meaningful purpose. ARP offers customers a convenience of using reward point in advance, in sufficient amount and at the right time. Take airline mileage incentive as an example, the time customers desire most to get such an incentive is when they are planning a trip and buying a ticket. However, they can not take advantage of the reward at this point if they are not the reward program member yet or they have insufficient amount of reward points accumulated. Although some programs allow customers to pay cash to buy points, such a method deviates from the most important feature of the reward—a feeling of free. At this sense, a reward program misses the best opportunity to acquire a new member or retain an existing member.

The sufficient value ARP can offer customers also expands the selection of incentives. In the above example, ARP sponsors can easily offer an ordinary customer a $1,000 value promotional item. Such an offer not only can attract most customers' attention, but also can deliver the exact type of incentive item customers want. Figure out a $100 item that most customers like is a tough job. While the limit is increased to $1,000, there will be a long name list that can fulfill the wishes of most customers. The maximum of reward advance also changes according to the expected spending level of customers. At this sense, the selection of incentives varies. Heavy spending customers can choose more expensive item while economic customers have less expensive selection. Such a distribution motivates customers in a much more scientific way to match their spending behaviors.

Compared with current reward programs, ARP has much better effect in locking up customers. Current reward program does not protect innovators very well. Followers can easily copy a new reward program or even provide a marginally higher reward rate to grab the customers away, because customer's switching cost is very low.

Previous reward program sponsor loses most of the investment of acquiring the members. ARP changes the situation. Since customers advance large amount of reward at the beginning, they will not switch to another reward program only for a marginally better choice. Even customers decide to leave, either they already spend enough for reward program operator to make a profit or the reward program operator gets a reasonable economic compensation by charging an interest on cash pay back.

ARP also provides a powerful tool for a coalition reward program. As described in the section of the Background of the Invention, average customer today can be the member of 4 to 5 reward programs. Consumers have to give up lots of reward points because those points scatter here and there. Whoever can run a coalition ARP that includes reward sponsors from different industries will be able to gain a great advantage in the reward industry. The lock up effect of ARP provides obvious first mover advantage to help the emergence of market leader to lead the convergence of different reward schemes.

Finally, ARP also opens the door for further innovations within reward marketing industry. There are many ways to design ARP around the basic embodiment of the present invention. Such as adding interest on reward advance, providing a revolving reward advance line, etc. Expansion of the selection of reward items will attract much more companies joining as reward sponsors. ARP also conducts the upfront self-selection. Consumers' choosing of offers tells the reward sponsor their future spending expectations. Reward program sponsors can use such kind of data to innovate the reward structures. For example, a merchant can provide different reward rates for customers based on different amount of reward advance in the specific time span.

It sounds too good to be true that all the participants can gain value. Values added to all participants of ARP can be practically realized because of the present invention can increase sales volume and decrease expenses for reward program operators.

Compared with current reward program practice, ARP sponsors not only can gain more customers and sales volume per customer, but also can improve the margin. With a more powerful marketing tool, ARP is attractive to more reward sponsors. With expanded selection of promotional items, it is easier for ARP sponsors to bargain a better deal with their suppliers or include higher margin items that can not be used before. ARP sponsors also can make money by savings on expenses. One of the biggest problems for reward program sponsor is inactive members. Lots of reward program sponsors' marketing money is wasted on gaining those inactive members. ARP programs have the function of self selection. Customers will tell ARP operator how much they are going to spend and how long they like to stay by selecting the reward advance offers. Active rate of ARP members will be significantly higher, 100% in theory, compared with a regular reward program. ARP helps reward program sponsors focus their investment on most valuable customers.

The development of information technology and internet makes the convergence of different systems and databases of different companies easier and more efficient, both economically and timely. The coalition reward program can fully take advantage of the present invention. The more reward sponsors, the more choices ARP can provide, the faster customer can accrue reward points, thus the higher value customers can advance. The development of information technology and internet also makes communication with customer convenient and inexpensive. The ubiquitous adoption of customer information management infrastructures across various industries further reduces the investment significantly in building a coalition reward program.

When the ARP in fact is also a new type of lending, risk is one of the major concerns on the viability of such an invention. And from customer's perspective, whether ARP puts more pressure on their purchase behavior so that makes them uncomfortable. Following through the further analysis of the sample offer, prove that above concerns are well addressed by the present invention.

The maturity of risk management techniques of financial institutions makes it easy and practical to extend a new type of credit. Unsecured consumer lending, especially credit card lending has been mature in the country. Credit card issuers offer American consumers lines of credit in trillion dollars. There is not any incremental investment is needed for card issuers to evaluate the creditworthiness of a member for a reward advance limit, especially combined with the process of offering the same customer a regular general purpose line of credit. Monthly minimum payment system, credit bureau reporting system and collection system are also the necessary parts that support the smooth management of reward point amortization.

Continue to use the above sample offer to demonstrate the present invention. A financial institution, credit card issuer specifically, participates in the ARP and evaluates the credit profile of the customer. Except for a regular credit line the card issuer offers, card issuer also assigns a line of $1,000 for reward points advance. ARP operator fulfills the reward advance in the form of a gift card, merchandise or travel package, etc. Then ARP operator sells the debt to the financial institution. In financial institution's monthly statements, there is a separate part for reward status. The customer is informed about the total reward advance balance, points earned during the period, total reward points available and the minimum points he or she has to amortize before a specific date, etc.

With careful design, the ARP protects the benefits of the financial institution and adds minimal pressure on customer. Table 1 is the amortization schedule for the sample offer. In this case, a one time bonus of 10,000 points (which is in line with the one time incentives provided by a few mainstream credit cars) is granted to the customer on the enrollment of the reward program. With this one time bonus, customer does not have to spend a lot right away to get enough points for the amortization. As calculated by table 1, the 10,000 bonus points can meet five months' amortization requirement. 2% monthly minimum requirement protects the customer from short term fluctuations of reward earning activities. 50% yearly minimum requirement makes sure that the customer spends enough as he promised and lowers the cost of the financial institution. Such a monthly minimum payment system works in the similar way as a credit card system does. There is minimal extra investment required to build and implement it.

TABLE 1
Reward Points Advance Balance Amortization Schedule

| | | | Maximum | | |
|---|---|---|---|---|---|
| | | | Period Do not | Monthly | Yearly |
| | | One Time | Have to Earn | Amortization | Amortization |
| | Beginning | Bonus | Points | Minimum | Minimum |
| Points | −100,000 | 10,000 | 5 months | 2,000 | 50,000 |
| % of Beginning | 100% | 10% | | 2% | 50% |
| Required | $50,000 | | | $1,000 | $25,000 |
| Purchase in a | | | | | |
| 2% Rebate | | | | | |
| Program | | | | | |

In case the customer does not have enough points to amortize minimum requirement, he or she can use cash to make up the gap (Table 2). However, an interest could be added by card issuer calculated from the date of the advance. The interest rate can vary from barely covering issuer's cost of fund to a regular or even a punitive rate specified in pre-determined terms. When customer defaults the amortization, the reward advance balance is translated into equivalent cash balance and treated the same way as any other cash balance on the credit account with the financial institution. From above example, we can see that the sophisticated credit extension, risk management and payment management system developed by financial institution, especially credit card issuer, can directly be borrowed with marginal revise to handle the reward point advance.

TABLE 2
Illustration of Cash Amortization

| | Reward | Points | Minimum | | Cash Payment |
|---|---|---|---|---|---|
| | Advance | Earned This | Amortization | Points | Required |
| Month | Balance | Period | Required | Available | (10% interest) |
| 6th | −80,000 | 1,000 | −2,000 | 1,000 | $10.5 |
| | (amortized 20% | | (2% of | | ($10 for points, |
| | already) | | −100,000) | | $0.5 for 6 |
| | | | | | months' |
| | | | | | interest at 10% |
| | | | | | rate) |

Another visualized demonstration can be done to prove the viability of the ARP offers. The economic sense of the present invention can be demonstrated by comparing ARP offer with 0% balance transfer offers broadly used in the credit card originations process. (Table 3)

The above sample is used again. And assume that the ARP is run completely by a credit card issuer. The purpose of the ARP is to gain new cardholders and encourage the spending of existing cardholders. The reward schedule is simple 1% cash back on purchases made through the reward card. Because a credit account is the important component of the ARP system, the value proposition of ARP for financial institution demonstrated by table 3 also proves the potential business value of the present invention.

TABLE 3
Comparison Between 0% Balance Transfer and ARP Offer

| | 0% Balance Transfer | ARP Offer in Above Example |
|---|---|---|
| Risk Exposure | Complete Credit Line | $1,000 |
| Cost | Cost of Funding The | Cost of Funding the Advance |
| | Balance | |
| Direct | No | Interchange Fees Exceeding the |
| Benefits from | | Reward Rate |
| Amortization | | |
| Lock Up | Yes, but not able to | Yes, and directly drive profit |
| Customer | directly drive profit | generating activities |
| | generating activities | |
| Retain | Customer can surf to | Customer has to pay interest in |
| Customers | another credit card | cash amortization part, which |
| | account without any | compensate card issuer for their |
| | cost and card issuer | investment |
| | earns nothing | |
| Other revenue | Credit balance | From discount provided by |
| stream | related | merchants or service providers |

### BRIEF DESCRIPTION OF THE DRAWINGS

A preferred embodiment of the present invention is the convergence of a credit extension system from a financial institution and a reward program sponsored by merchants, service providers, financial institutions, etc. Because of the popularity of reward program among financial services industry, especially credit card issuers, a financial institution/credit card issuer can easily employ the present invention to build and run an Advance Reward Program independently.

Above and other possible employments, objects and advantages of the present invention will become apparent from the following description of the preferred embodiments with reference to the drawings, in which;

FIG. 1 demonstrates a preferred embodiment of the business process and computer system layout in a multiple partner advanced reward program.

FIG. 2: value propositions of different participants of the preferred embodiment.

### DETAILED DESCRIPTION OF PREFERRED EMBODIMENT

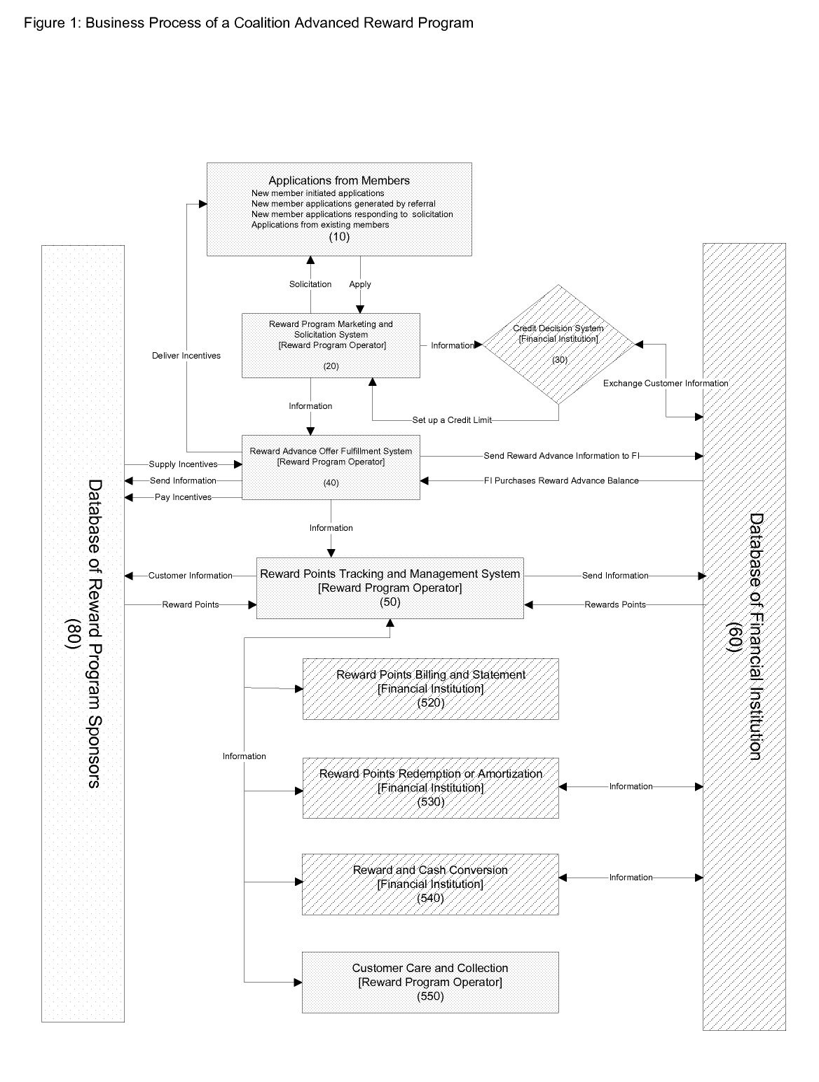

FIG. 1.

The embodiment of FIG. 1 is a coalition reward program that uses the business process of the present invention to offer customers reward points advance. To help the demonstration, hereinafter we name the coalition reward program as the ARP Network. The organization runs the ARP Network is referred to as the Operator hereinafter. A financial institution (hereinafter referred to as the FI) is involved to assess the creditworthiness of members of the program and manage the credit accounts of the members. Multiple partners (hereinafter referred to as the Reward Sponsor) participate the ARP Network from various industries. Reward Sponsors either provide reward points on the purchases made by members of the ARP Network or supply reward vehicles for the Operator. The customer who applies for reward point advance from the ARP Network is referred to as the Member hereinafter.

As described in FIG. 1, the business process starts from the Member's application for reward point advance (10 of FIG. 1). The application can be initiated by the Member or be the Member's response to the solicitation from Marketing and Solicitation System of the ARP Network (20 of FIG. 1). The Member maybe is new to the ARP Network or already an existing member. The Operator can design different incentive plans for different types of members. The application generated by referral (10 of FIG. 1) includes but not limited to the applications generated from Reward Partners and the FI, especially from FI with whom the Member is applying for a credit account of other purpose.

FIG. 1 labels the ownership of each module in square brackets under the name of each module. Such a method is only for demonstration purpose. In fact, the ownership of those modules can be totally different depending on which way makes more sense from economic perspective. And the Member maybe only see the interface of a dominating brand, either the FI, the Operator or one of the Reward Sponsors.

The applicant of the Member is routed to the Credit Decision System (30 of FIG. 1) of the FI. In many cases, such an evaluation is in conjunction with the evaluation for the Member's opening an independent credit account with the FI. Credit decision process can be exactly the same as what FI does without the consideration of the ARP Network. However, it is better off for FI to revise the process by incorporating the influence of reward point advance. In case no revision is conducted by the FI, a simple formula can be followed, such as to separate part of the credit limit FI would have extended as reward advance limit. For example, if FI would have offered the Member a $10,000 credit line in a regular credit extension, now it only offers the member $9,000 credit line for general purpose and $1,000 line for reward advance. Of course, Members who do not qualify for credit at all will be excluded from the reward advance offer except that some kind of security or collateral is provided.

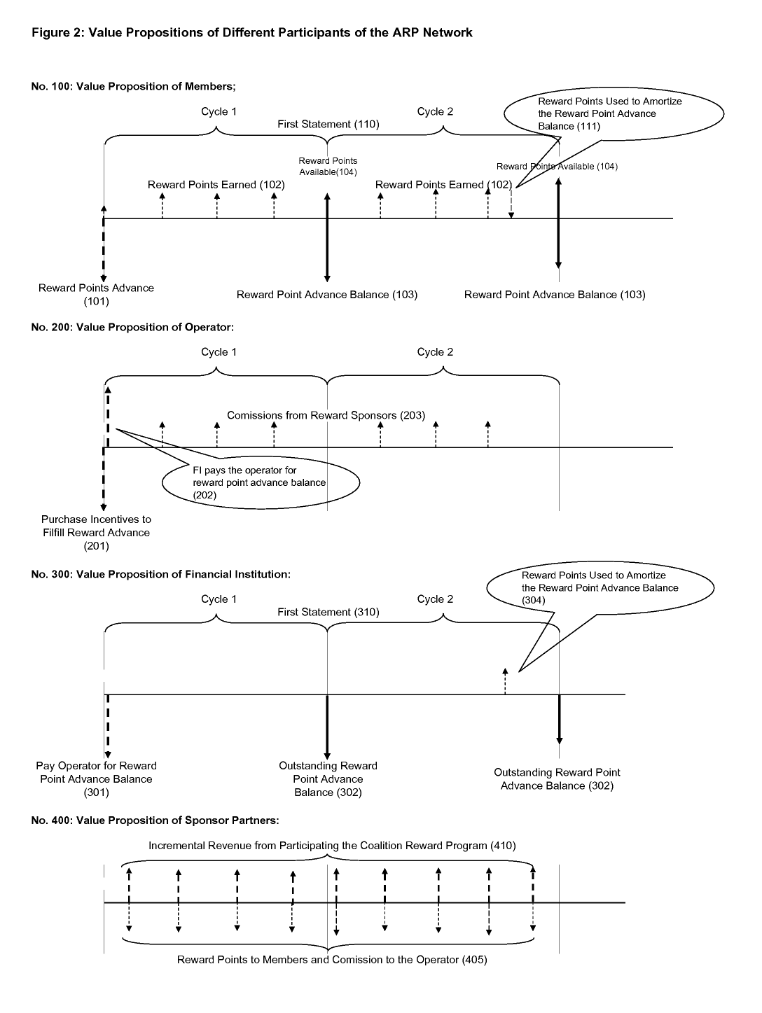

After the Member is approved a credit for reward point advance, the credit decision was sent back to the Operator's computer system. If the Member's application represents a firm offer in which the amount and method of reward is clearly said, the Operator directly delivers the information to Reward Advance Offer Fulfillment System (40 of FIG. 1) to fulfill the reward point advance offer. Otherwise, the Operator needs to communicate with the Member to set up the reward advance amount and method. In the process of fulfilling the reward advance offer, The Operator works with Reward Partners in agreed terms. Delivery, return policy, customer service and transaction between the Operator and Reward Sponsors are finished at this stage. Depending upon the negotiation, the Operator can purchase the reward item or service from Reward Sponsors then re-sell them to the Member in point currency or Operator charges a commission on items or services that Reward Sponsors deliver to the Member. In the former case the Operator takes risk but could make higher return and in the latter case the Operator earns a fixed percentage of return. Another transaction also happens at this point between the Operator and the FI. The FI purchases reward advance debt of the Member from the Operator to finance the up-front incentive process. The purchase value can be in a discount, on par or in a premium, according to the contract between the Operator and FI. In FIG. 2, more visualized transaction process is presented to explain how each party related with the ARP Network gains value.

In accordance with the principle of the present invention, a set of software and hardware for Reward Points Tracking and Management System (50 of FIG. 1) is developed by the Operator. Technically, Operator's method, software and hardware focus on communication and organization of those sub-systems embedded in FI, Reward Sponsors and Operator's infrastructures. Reward Points Tracking and Management System communicates with the FI and Reward Sponsors on real time or batch basis to gather the data of Member's reward earning activity and update reward point balance. On specific time span or triggered by specific event, such as end of the billing cycle or a call from the Member, some sub-system accesses the Reward Points Tracking and Management System to get the information and perform required functions. Those sub-systems include: Reward Points Billing and Statement (520 of FIG. 1), Reward Points Redemption or Amortization (530 of FIG. 1), Reward and Cash Conversion (540 of FIG. 1) and Customer Care and Collection (550 of FIG. 1).

Reward Points Billing and Statement module in preferred embodiment is an add-on to established billing system of the FI. The billing system of ARP can be built on top of billing system of the FI for general purpose cash balance. Reward Points Billing and Statement module summaries the changes of cardholder's reward points and informs the status and redemption/amortization requirement in the periodical statement. In the statement, at least following information is delivered to the Member in a clear and concise way: the balance of reward points advanced, minimum required amount of points to be amortized, the points earned in the past period, total available points to amortize the advancement, and if the amount of available points is less than minimum amortization requirement, the amount of cash payment needed.

Second sub-system is a Redemption or Amortization System (530 of FIG. 1). In accordance of the principle of the present invention, a convenient method of redeeming or amortizing the reward points is to be built for the Member. A paper coupon on which cardholder can write down point amount and mail to card issuer is also necessary, at least when the Member prefers so. In today's technique environment, a web based reward point redemption and amortization system is part of the embodiment of the present invention. The member can get the real time information about reward point balance and make amortization or redemption instruction at any time.

Third sub-system is a Reward and Cash Conversion module (540 of FIG. 1). When the amount of Member's reward points earned is not enough to amortize the minimum amortization required or any behavior of the Member triggers the punishment terms, the Reward and Cash Conversion Module has to convert the corresponding reward points into equivalent cash value. According to the pre-determined agreement, an interest rate, fee or other type of surcharge could be added into the Member's account as the expense of cardholder's breaking the contract.

The last sub-system is a Customer Care and Collection module (550 of FIG. 1). Although the FIG. 1 labeled this sub-system's ownership to the Operator, in the reality, the FI usually takes charge at least part of the work.

During the whole process, each module has to exchange information frequently with databases of the FI (60 of FIG. 1) and Reward Sponsors (80 of FIG. 10). Such an information exchange process is demonstrated with pointed lines in the FIG. 1.

In FIG. 1, there are also pointed lines used to describe the business relationships between the participants of the ARP Network. A separate drawing, FIG. 2, introduces more details on the value propositions of each participant and the business relationships between them.

Although preferred embodiment is a coalition reward program, more implementations of the present invention could be proprietary reward programs run and sponsored by a single organization, such as a credit card issuer. Many such kind of proprietary reward programs have already established some basic credit extension, risk management and reward marketing platforms. By simply changing the Operator to reward department, the FIG. 1 can well represent the spirit or basic process of a proprietary reward program.

FIG. 2:

FIG. 2 demonstrates the value propositions of each participant of the ARP Network and the transactions among different participants. In the FIG. 2, activities within first two cycles were presented. Further cycles are ignored because they are similar to the second cycle. Dash pointed lines in the FIG. 2 represent the transactions and solid pointed lines represent the balance.

The Member (No. 100), as in a regular reward program, earns points (102) through purchases, payments and other promotional activities in each cycle. In ARP Network, the Member advanced a lump sum (101) incentive in the form of merchandise, services or even cash at the beginning. At the end of the each cycle, the status of reward points was calculated and summed. The member is informed in the statement (110) about the amount of reward point advance balance (103), total reward points earned, total reward points available (104) to use and minimum reward points amortization required before specific date. In the next cycle, the member makes an amortization (111 ) with the available points to keep his/her account status current.

The Operator (No. 200) makes money through the commissions (203) reward sponsors provided based on the volume of sales from the members of the ARP Network. At the beginning of the program, Operator provides the reward advance (201) and later, the FI bought the balance (202).

FI (No. 300) provides the financing to the Member in the form of paying the Operator for reward point advance balance (301). The FI keeps this balance (302) on its book, informs the member to amortize in the periodical statement (310) and then collects the reward points from customers (304) to retire the debt. To keep the drawing simple, the FIG. 2 directly allocates the Member's point amortization to the FI's book. However, the actual money value is passed through the Oparator's system. For the FI, the value of the ARP Network mainly comes from the benefits of increased new customer acquisition, lower churn rate of existing customers a higher usage of its product, such as a credit card. In the section of Summary of the New Method, one simple comparison between a balance transfer and an ARP offer was demonstrated to prove such a value proposition. However, final business relationship between the Operator and the FI will be decided by many factors. By paying the Operator with a discount or premium to purchase the rewards advance balance, FI and the Operator can adjust their profit sharing.

Reward Sponsors (No. 400), including the FI if it also grants rewards to the Member, provide the reward points to customers and commissions to the Operator (405). And at the mean time, they enjoy the incremental revenues from Members of the ARP Network (410).

Others

Overall, the purpose of present invention is to develop a business method to realize economically viable practice of reward advance as a powerful marketing strategy. Loyalty marketers, especially reward program sponsors, and related financial institutions are the parties that benefit most from the invention. And with a new marketing tool, any related industry, such as retailers, airlines and manufactures, can take advantage it if they appropriately leverage their own strengths and the spirit of the present inventions.

The present invention uses examples and descriptions to demonstrate the logic, concept and method of building an Advance Reward System. Those skilled in the art will recognize that changes and modifications may be made in the described embodiments without departing from the nature and scope of the present invention.

Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method for a reward program operator to provide a customer a service of advancing reward points. The method comprising steps of:
a) conducting a credit evaluation on the customer and determining a limit of advance amount for the said customer.
b) offering said customer choices and methods to make an reward points advance.
Wherein said the offer also includes terms that said customer has to follow, among said terms are a minimum amortization amount requirement on specific time interval and action plans if said consumer defaults any part of the said terms.
c) by accepting said offer, said customer incurring a debt in the form of reward point advance balance.
d) using an electronic system to track the balance of reward points advance of said customer, amount of reward points said customer earns and all other reward points changes caused by pre-determined activities.
e) informing said customer, in a predetermined time interval, the status of reward points and the amount of amortization said customer has to make before a specific date.

2. The method of claim 1 wherein said reward program operator can be an independent organization, an affiliate of an organization, a department of an organization or a functional team or people of an organization.

3. The method of claim 1 wherein said reward points further includes any other term used to describe a unit of reward or rebate given to the said customer for his/her predetermined activities.

4. The method of claim 1 wherein said conducting a credit evaluation further includes getting a credit evaluation from a partner.

5. The method of claim 1 wherein said offering customer choices and methods can happen before said credit evaluation or after said evaluation.

6. The method of claim 1 where said advancing further including the meanings of lending, loan or overdraft.

7. A method to conduct loyalty marketing through providing reward point advance. The said method comprising of;
a) providing or offering a customer a choice to advance reward points before those points are earned.
b) managing reward points advanced by said customer through a cycle based minimum amortization system.
c) requiring said customer to pay cash for the difference between minimum amortization amount and total reward points available at required amortization date, if the absolute amount of the former is larger than the latter

8. The method of claim 7, wherein said loyalty marketing further includes promotional marketing which aims at attracting new customers or motivating existing customers with an event or special offer.

9. The method of claim 7, wherein said reward points further includes any other term used to describe a unit of reward or rebate given to the said customer for his/her predetermined activities.

10. The method for issuing and managing a loan based on rewards earned in the future, the method comprising of;
a) accessing the creditworthiness of a member or potential member of a reward program and deciding a credit limit for the said member;
b) offering said customer choices and methods to make an reward points advance;
Wherein said the offer also includes terms that said customer has to follow, among said terms are a minimum amortization amount requirement on specific time interval and action plans if said consumer defaults any part of the said terms.
c) using an electronic system to track the balance of reward points advance of said customer, amount of reward points said customer earns and all other reward points changes caused by pre-determined activities.
d) informing said customer, in a predetermined time interval, the status of reward points and the amount of amortization said customer has to make before a specific date.

11. The method of claim 10 wherein said reward points further includes any other term used to describe a unit of reward or rebate given to the said customer for his/her predetermined activities.

12. The method of claim 10 wherein said reward program can belong to an independent organization, an affiliate of an organization, a department of an organization or a functional team or people of an organization.

13. The method of claim 10 wherein said offering customer choices and methods can happen before said credit evaluation or after said evaluation.

14. The method of claim 10 where said advancing further including the meanings of lending, loan or overdraft.
